(19) United States
(12) Patent Application Publication
(10) Pub. No.: US 2022/0076320 A1
(43) Pub. Date: Mar. 10, 2022

(54) CONTENT RECOMMENDATION METHOD, DEVICE, AND STORAGE MEDIUM

(71) Applicant: Beijing Baidu Netcom Science Technology Co., Ltd., Beijing (CN)

(72) Inventors: Bingjie HU, Beijing (CN); Shichen SHAO, Beijing (CN); Yongheng LI, Beijing (CN); Yufang ZHANG, Beijing (CN)

(21) Appl. No.: 17/530,672

(22) Filed: Nov. 19, 2021

(30) Foreign Application Priority Data
Nov. 22, 2020 (CN) 202011526586.7

(51) Int. Cl. G06Q 30/06; G06N 5/02

(52) U.S. Cl. CPC G06Q 30/0631; G06N 5/02

(57) ABSTRACT

A content recommendation method, a device, and a storage medium are provided, which are related to technical fields of knowledge graph, big data, and the Internet. The specific implementation scheme includes: determining, among candidate producers, a target producer to whom a private domain content recommendation is performed according to product information of the candidate producers; establishing a recommended product set according to correlation among product information of the target producer; and performing a private domain content recommendation to the target producer based on the recommended product set.

### CROSS-REFERENCE TO RELATED APPLICATIONS

This application claims priority to Chinese patent application, No. 202011526586.7, entitled “Content Recommendation Method and Apparatus, Device, Storage Medium, and Program Product”, filed with the Chinese Patent Office on Dec. 22, 2020, which is hereby incorporated by reference in its entirety.

### TECHNICAL FIELD

The present disclosure relates to a technical field of computers, in particular, to technical fields of knowledge graph, big data, and the Internet.

### BACKGROUND

In today's Internet era, producers are concerned about not only public domain traffic shared by the collective, but also private domain traffic belonging to a single individual. Private domain traffic involves traffic which is owned by a brand or a producer autonomously, does not need to be paid for, can be reused, and can reach users at any time. Recommending content for a producer can help the producer gain traffic.

Current methods of content recommendation for producers mainly include a network-wide recommendation and a provision of private domain recommendation tools to producers.

### SUMMARY

According to the present disclosure, a content recommendation method and apparatus, a device, a storage medium, and a program product are provided.

According to an aspect of the present disclosure, a content recommendation method is provided. The method includes:

determining, among candidate producers, a target producer to whom a private domain content recommendation is performed according to product information of the candidate producers;

establishing a recommended product set according to correlation among product information of the target producer; and

performing a private domain content recommendation to the target producer based on the recommended product set.

According to another aspect of the present disclosure, a content recommendation apparatus is provided. The apparatus includes:

a determination unit, configured for determining, among candidate producers, a target producer to whom a private domain content recommendation is performed according to product information of the candidate producers;

an establishment unit, configured for establishing a recommended product set according to correlation among product information of the target producer; and

a recommendation unit, configured for performing a private domain content recommendation to the target producer based on the recommended product set.

According to yet another aspect of the present disclosure, there is provided an electronic device, including:

at least one processor; and

a memory communicatively connected to the at least one processor, wherein

the memory stores instructions executable by the at least one processor, and the instructions are executed by the at least one processor to enable the at least one processor to perform the method according to any one of the embodiments of the present disclosure.

According to yet another aspect of the present disclosure, a non-transitory computer-readable storage medium storing computer instructions is provided, wherein the computer instructions, when executed by a computer, cause the computer to perform the method according to any one of the embodiments of the present disclosure.

According to yet another aspect of the present disclosure, there is provided a computer program product comprising a computer program, which, when executed by a processor, cause the processor to implement the method according to any one of the embodiments of the present disclosure.

It should be understood that content in this section is not intended to identify key or critical features of embodiments of the present disclosure, nor is it intended to limit the scope of the present disclosure. Other features of the present disclosure will become readily apparent from the following description.

### BRIEF DESCRIPTION OF THE DRAWINGS

The drawings are used to better understand the scheme and do not constitute a limitation to the present disclosure. In the drawings:

FIG. 1 is a flowchart showing a content recommendation method according to an embodiment of the present disclosure:

FIG. 2 is a flowchart showing a determination of a target producer based on a content recommendation method according to another embodiment of the present disclosure:

FIG. 3 is a flowchart showing a correlation analysis based on a content recommendation method according to another embodiment of the present disclosure;

FIG. 4 is a flowchart showing a correlation analysis based on a content recommendation method according to another embodiment of the present disclosure;

FIG. 5 is a flowchart showing an optimization of a product set based on a content recommendation method according to another embodiment of the present disclosure;

FIG. 6 is a flowchart showing a content recommendation method according to another embodiment of the present disclosure:

FIG. 7 is a schematic diagram showing a content recommendation apparatus according to an embodiment of the present disclosure;

FIG. 8 is a flowchart showing a content recommendation apparatus according to another embodiment of the present disclosure:

FIG. 9 is a flowchart showing a content recommendation apparatus according to another embodiment of the present disclosure;

FIG. 10 is a flowchart showing a content recommendation apparatus according to another embodiment of the present disclosure; and

FIG. 11 is a block diagram showing an electronic device used for implementing a content recommendation method according to an embodiment of the present disclosure.

### DETAILED DESCRIPTION

Exemplary embodiments of the present disclosure will be described below in combination with drawings, including various details of embodiments of the present disclosure to facilitate understanding, which should be considered as exemplary only. Therefore, those of ordinary skill in the art should realize that various changes and modifications can be made to the embodiments described herein without departing from the scope and spirit of the present disclosure. Likewise, descriptions of well-known functions and structures are omitted in the following description for clarity and conciseness.

In related technologies, methods of content recommendation for producers mainly include following technical schemes:

Scheme I: a private domain recommendation is not carried out, and only a network-wide recommendation is provided. A platform performs similar matching recommendations according to dimensions of content correlation, product category and the like of products of all producers. When a user browses a product of a certain producer, in most cases, related products of other producers will be recommended to the user, while products of the current producer are rarely recommended.

Scheme II: a platform provides private domain recommendation tools to producers. The producers need to manually configure product content to be recommended for each product in the background.

By applying above technical schemes, following deficiencies exist:

According to the scheme I, producers providing high-quality content do not enjoy additional traffic provided by a platform, and the producers' own traffic is shunted due to a network-wide recommendation, resulting in high customer acquisition costs for the producers. The lack of motivation for producers to produce high-quality content results in the loss of high-quality producers, which is not conducive to the ecological construction of content on a platform.

According to the scheme II, the manual configuration of private domain recommendation products is inefficient and inconvenient for producers to configure in batches. In addition, based on the scheme, it is impossible to adjust recommendation content in real time according to recommendation effects such as user behavior data, so that the content recommendation effect cannot be guaranteed, which is not conducive to the improvement of income of producers and of platform revenue.

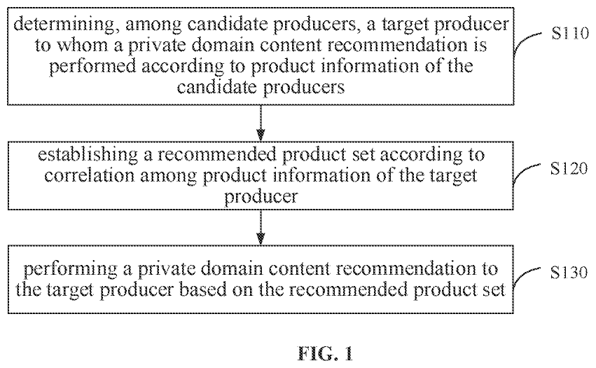

FIG. 1 is a flowchart showing a content recommendation method according to an embodiment of the present disclosure. Referring to FIG. 1, the content recommendation method includes:

S110, determining, among candidate producers, a target producer to whom a private domain content recommendation is performed according to product information of the candidate producers:

S120, establishing a recommended product set according to correlation among product information of the target producer; and

S130, performing a private domain content recommendation to the target producer based on the recommended product set.

Internet traffic can be divided into public domain traffic and private domain traffic. Public domain traffic, also referred to as platform traffic, does not belong to a single individual, but is shared by the collective. For example, in a marketing platform, public domain traffic may involve traffic that sellers may all obtain rankings at public display sites for promotion. Private domain traffic is traffic belonging to a single individual. Private domain traffic involves traffic which is owned by a brand or a producer autonomously, and does not need to be paid for, and it involves a channel by which the user can be reached directly at any time and at any frequency. In the marketing platform, private domain traffic can be traffic brought by marketing the content of a store. For example, private domain traffic may be traffic brought by marketing the content in a product display webpage, such as related product recommendations, live broadcasts, and group chats.

Taking knowledge stores such as “libraries” as an example, with the rapid expansion of online knowledge content and the exhaustion of traffic dividends, the cost for customer acquisition by content producers becomes higher and the monetization under public domain traffic becomes more and more difficult. Content recommendation for producers can help the producers gain traffic.

According to an embodiment of the present disclosure, there is provided a content recommendation method, which can ensure the effect of content recommendation and reduce the cost of acquiring customers for producers. In S110, taking the “libraries” as an example, all content producers in the libraries can be selected as candidate producers. Product information of candidate producers are extracted, where the product information may include key information points such as product content, traffic, and payment rate. High-quality content producers are identified according to the product information of the candidate producers. The high-quality content producers are regarded as target producers to whom private domain content are recommended. In an embodiment of the present disclosure, determining, among candidate producers, a target producer to whom private domain content is recommended may specifically include: determining identification information of the target producer to whom the private domain content is recommended from identification information of a plurality of candidate producers. The identification information of a producer may include information such as a username, and a shop name of the producer.

In S120, for the target producers determined in S110, correlation among respective product information produced by the target producers is analyzed before private domain content is recommended for then. A recommended product set is established according to the correlation among the product information, and the target producers' own products with larger correlation with current products are recommended in a current product display webpage. For example, product information of the target producers can be obtained based on identification information of the target producer, and the correlation among the product information of the target producers is analyzed, so that a recommendation is carried out.

In S130, a private domain recommendation function is enabled for the target producers based on the recommended product set. Recommended content may include the target producers' own relevant high-quality content in the recommended product set. Taking a knowledge store as an example, a system can recommend knowledge commodities in the store with high correlation with commodities in a current display webpage for the target producers in a store commodity display webpage of the knowledge store.

By applying an embodiment of the present disclosure, private domain content can be recommended for a high-quality producer based on a recommended product set, the customer acquisition efficiency of the high-quality producer can be effectively improved, the customer acquisition cost can be reduced, marketing cost is saved, and sales volume is improved, so that producers are helped to effectively build personal brands. In addition, by applying an embodiment of the present disclosure, it may better guarantee the overall income of a marketing platform, and may guarantee the marketing for ensuring a long-term healthy development of the platform.

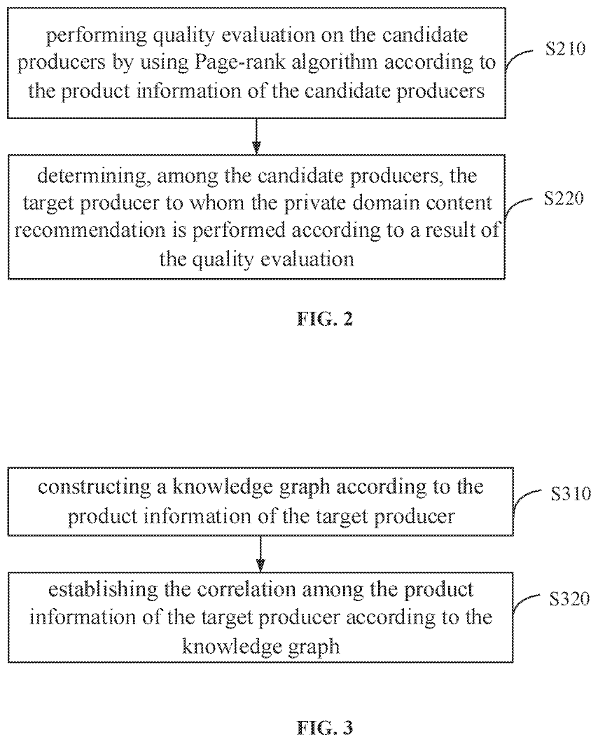

FIG. 2 is a flowchart showing a determination of a target producer based on a content recommendation method according to another embodiment of the present disclosure. As shown in FIG. 2, in an implementation, S110 in FIG. 1, determining, among the candidate producers, the target producer to whom the private domain content recommendation is performed according to the product information of the candidate producers, can specifically include:

S210, performing quality evaluation on the candidate producers by using Page-rank algorithm according to the product information of the candidate producers; and

S220, determining, among the candidate producers, the target producer to whom the private domain content recommendation is performed according to a result of the quality evaluation.

The Pagerank algorithm is also referred to as webpage-level algorithm. By using the algorithm, the importance level of a page can be determined by analyzing and calculating mutual hyperlinks between webpages.

In the case of taking knowledge stores as an example, product information for candidate producers, such as product content and traffic data, current inventory, and newly added product content, may be analyzed. A quality evaluation on the candidate producers may be performed by using Pagerank algorithm according to the product information of the candidate producers, and a high-quality producer measurement standard is established. The target producer to whom the private domain content recommendation is performed is determined according to a result of the quality evaluation and the high-quality producer measurement standard.

Taking the libraries as an example, each candidate producer is abstracted into a node by using the Pagerank algorithm, and relevant factors of all candidate producers and their commodities in the libraries are abstracted into a directed graph according to factors such as the quantity of commodities of producers, content quality, price range of commodities, pageviews, downloads, sales volume of commodities, attention amounts, the payment conversion rate, producer scores, user scores, copyrights, and user comments. The data related to above factors are integrated to calculate a high-quality score (a) of each candidate producer, and to establish a high-quality producer measurement standard. An exemplary measurement standard is shown in Table 1.

TABLE 1
High-quality producer measurement standard

| Threshold | Interpretation |
|---|---|
| (0, 3) | The quality of producers is low, content provided |
| | by them is with poor quality, and user satisfaction |
| | is low, so that it is not suitable to perform |
| | private domain recommendation. |
| [3, 4) | The quality of producers is moderate, overall |
| | content may be improved, so that private domain |
| | recommendation function can be enabled after the |
| | improvement. |
| [4, 5] | The quality of producers is high, so that it is |
| | suitable to enable the private domain |
| | recommendation function. |

In an example, a quality assessment of candidate producers may be performed periodically, such as monthly. Newly added candidate producers meeting the condition of enabling the private domain recommendation function can be determined as target producers, and private domain content can be automatically recommended to the candidate producers. For producers, for whom the private domain recommendation function has been already enabled but the above conditions are no longer met, the private domain traffic recommendation function is disabled.

By applying an embodiment of the present disclosure, a quality evaluation is performed on candidate producers by using the Pagerank algorithm, and the target producers to whom the private domain content recommendation is performed are determined among the candidate producers, so that producers are motivated to improve the quality of their own products in order to obtain opportunities of private domain content recommendation. Therefore, in above manner, producers are guided to iteratively upgrade, so that their quality are improved, and they become high-quality producers.

FIG. 3 is a flowchart showing a correlation analysis based on a content recommendation method according to another embodiment of the present disclosure. As shown in FIG. 3, in an implementation, the method further includes:

S310, constructing a knowledge graph according to the product information of the target producer; and

S320, establishing the correlation among the product information of the target producer according to the knowledge graph.

In this implementation, the Canonical Correlation Analysis (CCA) method in data mining can be used to mine knowledge points according to basic attributes of a product, such as the title, content, classification, key words of the product, and a knowledge graph is built according to mined knowledge points. The correlation among products can be established according to the knowledge graph. Each product may be taken as an element in the knowledge graph, and the relationship among the elements in the knowledge graph may represent the correlation among product information. In the embodiment of the present disclosure, the correlation among the product information of the target producers established according to the knowledge graph is referred to as basic correlation.

According to an embodiment of the present disclosure, basic correlation among product information of target producers is established according to a knowledge graph, a recommended product set can be established according to the basic correlation in a subsequent process, so that the correlation between recommended content and a current product is larger, thereby achieving a better private domain content recommendation effect.

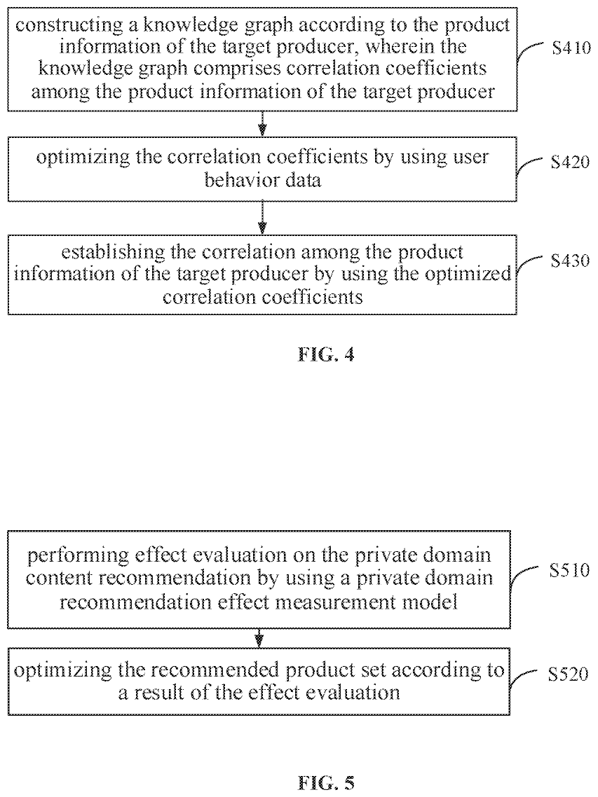

FIG. 4 is a flowchart showing a correlation analysis based on a content recommendation method according to another embodiment of the present disclosure. As shown in FIG. 4, in an implementation, the method further includes:

S410, constructing a knowledge graph according to the product information of the target producer, wherein the knowledge graph comprises correlation coefficients among the product information of the target producer:

S420, optimizing the correlation coefficients by using user behavior data; and

S430, establishing the correlation among the product information of the target producer by using the optimized correlation coefficients.

In this implementation, a knowledge graph is constructed based on product information, and correlation among producers' own commodity information is established by combining with user behavior data. A basic recommended commodity set can be established according to the correlation in a subsequent process.

Based on a target producer selected in S10, product information of the target producer can be analyzed according to following steps.

1) Knowledge points are mined according to basic attributes of a product, such as the title, content, classification, key words of the product, and a knowledge graph is built according to mined knowledge points. Basic correlation among product information of target producers is established according to the knowledge graph. For related content of establishing basic correlation, please refer to the related description of the embodiment shown in FIG. 3, which will not be repeated here.

In the knowledge graph, correlation between two kinds of product information is expressed by basic correlation coefficients.

2) The basic correlation coefficients are optimized by combining with user behavior data, such as user searching, browsing, purchasing, user comments. For example, for a product that is well commented by a user, the correlation between the product and products presented on a current page is increased for preferential recommendation. Cost Per Mille (CPM) based deep correlation among product information of target producers can be established by using optimized correlation coefficients. The CPM is a calculation unit for calculating the cost of media serving 1,000 people or “family”. The CPM can be calculated using the following formula:

CPM=User Purchase Amount/Page PV*1000:

where PV is the abbreviation for Page View, i.e., page views.

According to above steps, correlation among producers' own commodity information is established, and on this basis, a basic recommended commodity set in the case of private domain recommendation can be established for each product. A product having large correlation with a current product is regarded as a product in the recommended commodity set, and content for the product in the recommended commodity set is recommended in a display webpage of the current product. The core goal of the recommendation is to maximize the CPM of traffic.

By applying an embodiment of the present disclosure, deep correlation among producers' own commodity information is established by constructing a knowledge graph according to product information and analyzing by using user behavior data, and a recommended product set can be established according to the deep correlation in a subsequent process, so that a product with good user experience can be recommended preferentially, thereby achieving a better private domain content recommendation effect.

Based on correlation among product information of a target producer established in S320 and S430, a recommended product set may be established according to the correlation. A ranking of a basic recommended commodity set is established according to a correlation degree. In an example, n content-related products may be recommended in a display webpage of each product of a knowledge store, and the top n products sorted in the recommended product set corresponding to the current product are introduced on the platform, and content is recommended in the display webpage of the current product.

FIG. 5 is a flowchart showing an optimization of a product set based on a content recommendation method according to another embodiment of the present disclosure. As shown in FIG. 5, in an implementation, the method further includes:

S510, performing effect evaluation on the private domain content recommendation by using a private domain recommendation effect measurement model; and

S520, optimizing the recommended product set according to a result of the effect evaluation.

In this implementation, a private domain recommendation effect measurement model may be built first. Then, a private domain recommendation effect of each commodity is calculated in a preset period according to data effect brought by adding the recommended commodity set as a new arrival, and the recommended commodity set is dynamically adjusted based on the private domain recommendation effect. For example, the preset period may be set to a day level, that is, the private domain recommendation effect of each commodity is calculated once a day, and the recommended commodity set is dynamically adjusted by the day level as an execution period based on the private domain recommendation effect.

By applying an embodiment of the present disclosure, a recommendation product set is optimized by utilizing a private domain recommendation effect measurement model, so that recommended content is more in line with user requirements, thereby achieving a better recommendation effect.

In an implementation, the method further includes performing the effect evaluation on the private domain content recommendation by means of at least one of following factors in the private domain recommendation effect measurement model.

a result of the quality evaluation of the target producer, content correlation among the product information of the target producer, quality of products in the recommended product set, and price correlation among the product information of the target producer.

The relationship between the private recommendation effect and each evaluation factor can be expressed by the following formula:

F(e)=f(c,q,n,p);

where F(e) represents a private domain recommendation effect. The private domain recommendation effect mainly depends on following factors.

1) A result c of quality evaluation of a target producer.

The result c of quality evaluation of a target producer can indicate whether the producer is with high quality. A private domain content recommendation is based on high-quality content producers. The higher the quality of a producer is, the better the effect of private domain recommendation is, and the better the profitability brought for a producer after a private domain recommendation is enabled.

2) Content correlation q among product information of a target producer.

The title of a product highly summarizes the content of the product. The content correlation q may also include title correlation. The higher the correlation between titles and content of recommended products, the more likely a user is to click and purchase, thereby rendering a better private domain recommendation effect.

3) Quality n of a product in a recommended product set.

Taking the “libraries” as an example, the quality n of a product in a recommended product set may include the content quality of an article in the “libraries”. In an example, a commodity quality star rating system may be used to evaluate products. When recommending commodities, high quality commodities should be selected as much as possible. The higher the overall quality of commodities, the better the recommendation effect.

4) Price correlation p among product information of a target producer.

On the one hand, psychological expectations of consumers should be considered for prices of recommended commodities. In a marketing platform, the average commodity purchase amount of each customer, i.e., the average transaction amount, is usually expressed in price per customer. If the price of a recommended commodity is higher than the consumer's psychological expectation, the demand decreases, and the price per customer becomes higher. If the price of a recommended commodity is lower than the consumer's psychological expectation, the demand increases, and the price per customer becomes lower. Therefore, it is necessary to consider the price correlation among product information of target producers in order to find out an optimal point the price of a recommended commodity.

On the other hand, for the price of a recommended commodity, the income of a producer needs to be taken into consideration. It is not true that the higher the price of commodities, the more income a producer receives. High pricing of commodities may result in less sales of commodities and decrease the income of producers. Appropriately low pricing of commodities may lead to more sales of commodities and increase the income of a producer. Firstly, under the premise that a producer can obtain the maximum income, a recommended commodity is given an appropriate pricing. Then, based on the pricing of the recommended commodity, the consumer's psychological expectations should be taken into consideration for the recommended commodity price, that is, the price of the recommended commodity should be not significantly different from the pricing of the commodity displayed on the current page.

In an embodiment of the present disclosure, a private domain recommendation effect measurement model based on a formula F (e)=f (c, q, n, p) is firstly established. Weight values corresponding to respective dependent factors of a private domain recommendation effect are set, and the preset weight values are used to calculate the private domain recommendation effect when the private domain recommendation effect measurement model is used at an initial stage (for example, when it is used for the first time, or for a period of time when the private domain recommendation effect measurement model starts to be used). The weight values are continuously optimized and iterated in subsequent use processes. The private domain recommendation effect measurement model is continuously optimized according to the private domain recommendation effect, and the private domain recommendation commodity set is continuously optimized based on the private domain recommendation effect measurement model. In an example, if n content-related products may be recommended in a display webpage for each product in the knowledge store, the optimization goal is: f(cpm)=F (e1)+F (e2)+ . . . +F (en) is maximized. i.e., the profit per thousand displays of content-related product recommendation combinations is maximized.

According to an embodiment of the present disclosure, evaluation factors are used to perform an effect evaluation on a private domain content recommendation, so that recommended content is more in line with the requirements of consumers, while a producer can obtain more income, thereby achieving a better recommendation effect.

In an example, machine and manual evaluation can be combined to evaluate the effect of a private domain content recommendation, and the high-quality producer measurement standard, the correlation model among product information and the private domain recommendation effect measurement model are continuously optimized, so that an optimal private domain recommendation product set is produced. For example, a second round of evaluation can be manually performed on the basis of a private domain recommendation effect measurement model, each model is continuously improved by adopting a manual scoring mechanism, and private domain recommendation commodities are regularly updated, so that an optimal private domain recommendation product set is produced, and the private domain recommendation effect is guaranteed.

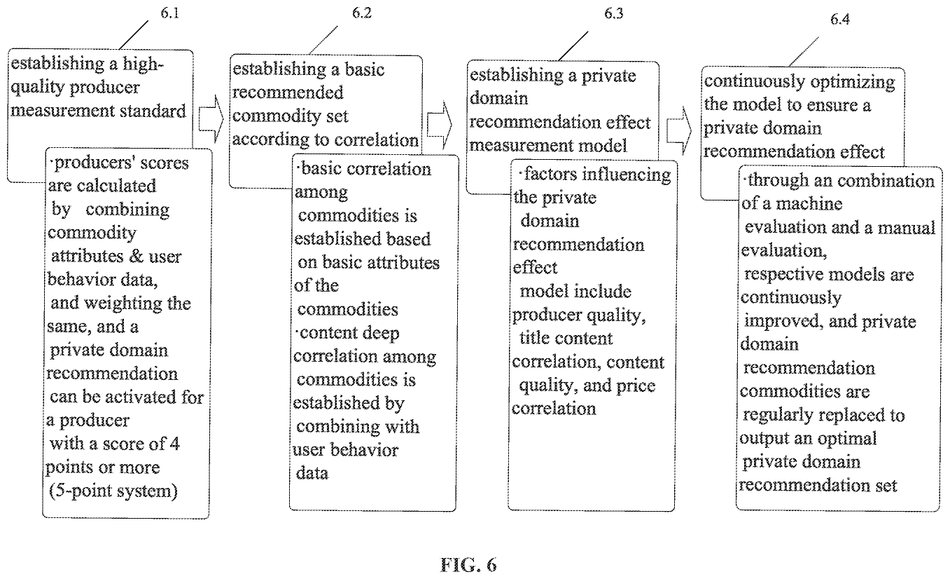

FIG. 6 is a flowchart showing a content recommendation method according to another embodiment of the present disclosure. As shown in FIG. 6, an exemplary content recommendation method includes following steps.

Step 6.1: establishing a high-quality producer measurement standard. Specifically, the step can include: calculating producer scores by combining commodity attributes and user behavior data, such as the page view and downloads, and weighting the same. In a five-point scoring system, a private domain recommendation function can be activated for a high-quality producer with a score of four points or more.

Step 6.2: establishing a recommended product set by utilizing the correlation among product information. Basic correlation among commodities is established based on basic attributes of the commodities. Content deep correlation among commodities is established by combining with user behavior data.

Step 6.3: establishing a private domain recommendation effect measurement model. Factors influencing the recommendation effect measurement model include producer quality, title content correlation, content quality, and price correlation.

Step 6.4: continuously optimizing the model to ensure a private domain recommendation effect. Specifically, the step can include: continuously improving respective models used in above steps through a combination of a machine evaluation and a manual evaluation, and regularly replacing private domain recommendation commodities, to output an optimal private domain recommendation set.

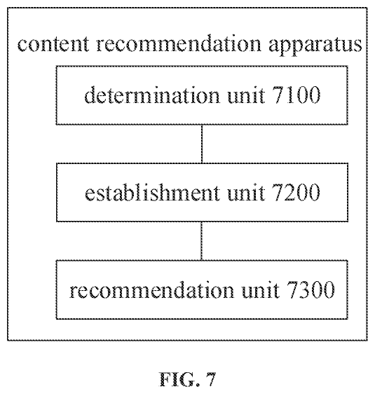

FIG. 7 is a schematic diagram showing a content recommendation apparatus according to an embodiment of the present disclosure. Referring to FIG. 7, the content recommendation apparatus includes:

a determination unit 7100, configured for determining, among candidate producers, a target producer to whom a private domain content recommendation is performed according to product information of the candidate producers;

an establishment unit 7200, configured for establishing a recommended product set according to correlation among product information of the target producer; and

a recommendation unit 7300, configured for performing a private domain content recommendation to the target producer based on the recommended product set.

In an implementation, the determination unit 7100 is configured for:

performing quality evaluation on the candidate producers by using Page-rank algorithm according to the product information of the candidate producers; and

determining, among the candidate producers, the target producer to whom the private domain content recommendation is performed according to a result of the quality evaluation.

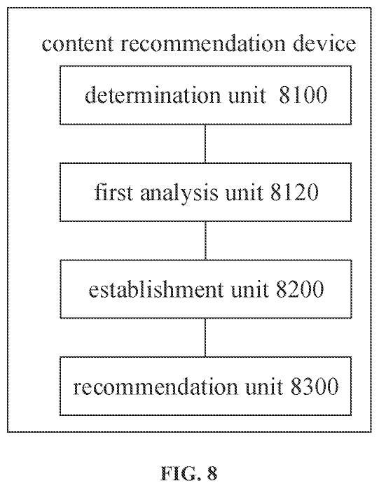

FIG. 8 is a flowchart showing a content recommendation apparatus according to another embodiment of the present disclosure. As shown in FIG. 8, in an implementation, in addition to a determination unit 8100, an establishment unit 8200, and a recommendation unit 8300, the above apparatus further includes a first analysis unit 120. Exemplary, the determination unit 8100, the establishment unit 8200, and the recommendation unit 8300 of FIG. 8 are identical or similar to the determination unit 7100, the establishment unit 7200, and the recommendation unit 7300 of FIG. 7. The first analysis unit 7120 is configured for:

constructing a knowledge graph according to the product information of the target producer; and

establishing the correlation among the product information of the target producer according to the knowledge graph.

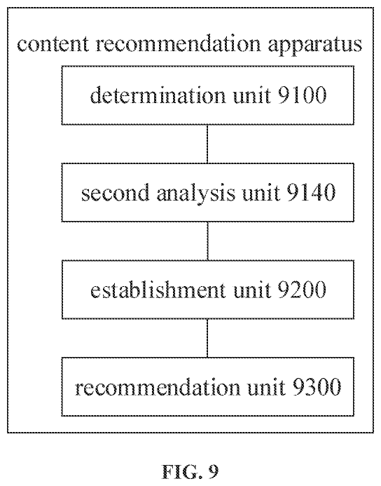

FIG. 9 is a flowchart showing a content recommendation apparatus according to another embodiment of the present disclosure. As shown in FIG. 9, in an implementation, in addition to a determination unit 9100, an establishment unit 9200, and a recommendation unit 9300, the above apparatus further includes a second analysis unit 9140. Exemplary, the determination unit 9100, the establishment unit 9200, and the recommendation unit 9300 of FIG. 9 are identical or similar to the determination unit 7100, the establishment unit 7200, and the recommendation unit 7300 of FIG. 7. The second analysis unit 7140 is configured for:

constructing a knowledge graph according to the product information of the target producer, wherein the knowledge graph comprises correlation coefficients among the product information of the target producer;

optimizing the correlation coefficients by using user behavior data; and

establishing the correlation among the product information of the target producer by using the optimized correlation coefficients.

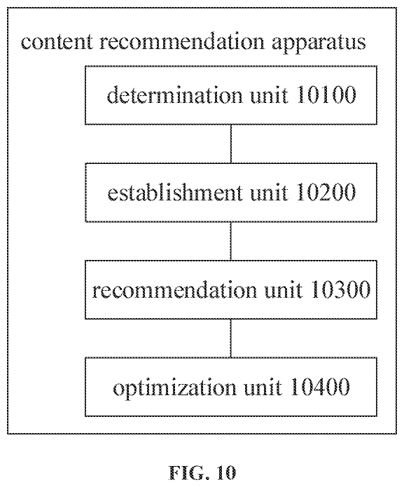

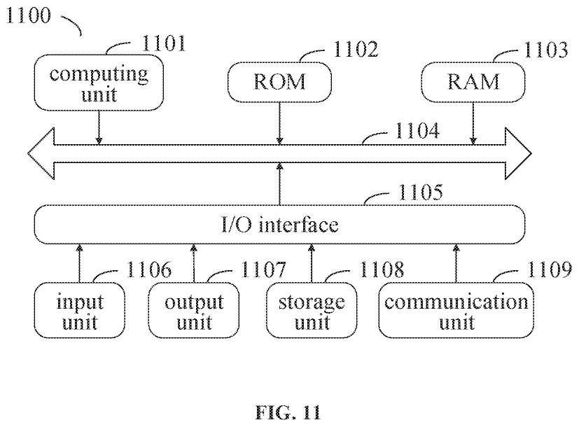

FIG. 10 is a flowchart showing a content recommendation apparatus according to another embodiment of the present disclosure. As shown in FIG. 10, in an implementation, in addition to a determination unit 10100, an establishment unit 10200, and a recommendation unit 10300, the above apparatus further includes an optimization unit 10400. Exemplary, the determination unit 10100, the establishment unit 10200, and the recommendation unit 10300 of FIG. 10 are identical or similar to the determination unit 7100, the establishment unit 7200, and the recommendation unit 7300 of FIG. 7. The optimization unit 10400 is configured for:

performing effect evaluation on the private domain content recommendation by using a private domain recommendation effect measurement model; and

optimizing the recommended product set according to a result of the effect evaluation.

In an implementation, the optimization unit 10400 is further configured for performing the effect evaluation on the private domain content recommendation by means of at least one of following factors in the private domain recommendation effect measurement model:

a result of the quality evaluation of the target producer, content correlation among the product information of the target producer, quality of products in the recommended product set, and price correlation among the product information of the target producer.

Regarding the functions of respective units of the content recommendation apparatus of embodiments of the present disclosure, reference can be made to corresponding descriptions in the above-mentioned method, which is not repeated in detail herein.

According to an embodiment of the present disclosure, an electronic device, a readable storage medium, and a computer program product are provided in the present disclosure.

FIG. 11 illustrates a schematic block diagram of an exemplary electronic apparatus 1100 that may be used to implement embodiments of the present disclosure. Electronic apparatuses are intended to represent various forms of digital computers, such as laptop computers, desktop computers, workbenches, personal digital assistants, servers, blade servers, mainframe computers, and other suitable computers. Electronic apparatuses may also represent various forms of mobile devices, such as personal digital assistants, cellular phones, smart phones, wearable devices, and other similar computing devices. The components shown herein, their connections and relationships, and their functions are merely examples, and are not intended to limit the implementation of the present disclosure described and/or claimed herein.

As shown in FIG. 11, the apparatus 1100 includes a computing unit 1101 that may perform various suitable actions and processes in accordance with a computer program stored in a read only memory (ROM) 1102 or a computer program loaded from a storage unit 808 into a random-access memory (RAM) 1103. In the RAM 1103, various programs and data required for the operation of the storage apparatus 1100 can also be stored. The computing unit 1101, the ROM 1102 and the RAM 1103 are connected to each other through a bus 1104. An input/output (IO) interface 1105 is also connected to the bus 1104.

A number of components in the apparatus 1100 are connected to the 1/O interface 1105, including an input unit 1106, such as a keyboard, a mouse, etc.; an output unit 1107, such as various types of displays, speakers, etc.; a storage unit 1108, such as a magnetic disk, an optical disk, etc.; and a communication unit 1109, such as a network card, a modem, a wireless communication transceiver, etc. The communication unit 1109 allows the apparatus 1100 to exchange information/data with other apparatuses over a computer network, such as the Internet, and/or various telecommunication networks.

The computing unit 1101 may be various general purpose and/or special purpose processing components having processing and computing capabilities. Some examples of the computing unit 1101 include, but are not limited to, a central processing unit (CPU), a graphics processing unit (GPU), various specialized artificial intelligence (AI) computing chips, various computing units running machine learning model algorithms, a digital signal processor (DSP), and any suitable processor, controller, microcontroller, etc. The computing unit 1101 performs various methods and processes described above, such as a content recommendation method. For example, in some embodiments, the content recommendation method may be implemented as a computer software program tangibly contained in a machine-readable medium, such as the storage unit 808. In some embodiments, some or all of computer programs may be loaded into and/or installed on the apparatus 1100 via a ROM 1102 and/or a communication unit 809. When a computer program is loaded into the RAM 1103 and executed by the computing unit 1101, one or more steps of the content recommendation method described above may be performed. Alternatively, in other embodiments, the computing unit 1101 may be configured to perform the content recommendation method by any other suitable means (e.g., via a firmware).

Various implementations of the systems and techniques described herein above may be implemented in a digital electronic circuit system, an integrated circuit system, a field programmable gate array (FPGA), an application specific integrated circuit (ASIC), an application specific standard product (ASSP), a system on a chip (SOC), a complex programmable logic device (CPLD), computer hardware, firmware, software, and/or combinations thereof. These various embodiments may include an implementation in one or more computer programs, which can be executed and/or interpreted on a programmable system including at least one programmable processor; the programmable processor can be a dedicated or general-purpose programmable processor, which can receive data and instructions from, and transmit data and instructions to, a memory system, at least one input device, and at least one output device.

Program codes for implementing methods of the present disclosure may be written in any combination of one or more programming languages. These program codes may be provided to a processor or a controller of a general-purpose computer, a special purpose computer, or other programmable data processing units, such that program codes, when executed by the processor or the controller, cause functions/operations specified in a flowchart and/or a block diagram to be performed. The program codes may be executed entirely on a machine, partly on a machine, partly on a machine as a stand-alone software package and partly on a remote machine, or entirely on a remote machine or a server.

In the context of the present disclosure, a machine-readable medium can be a tangible medium that may contain or store a program for use by or in connection with an instruction execution system, device, or apparatus. The machine-readable medium may be a machine-readable signal medium or a machine-readable storage medium. The machine-readable medium may include, but is not limited to, electronic, magnetic, optical, electromagnetic, infrared, or semi-conductive systems, devices, or apparatuses, or any suitable combination thereof. More specific examples of the machine-readable storage medium may include one or more wire-based electrical connections, a portable computer diskette, a hard disk, a random-access memory (RAM), a read-only memory (ROM), an erasable programmable read-only memory (EPROM or Flash memory), an optical fiber, a portable compact disk read-only memory (CD-ROM), an optical storage apparatus, a magnetic storage apparatus, or any suitable combination thereof.

In order to provide interactions with a user, the system and technology described herein may be implemented on a computer having a display device (for example, a cathode ray tube (CRT) or a liquid crystal display (LCD) monitor) for displaying information to the user; and a keyboard and pointing device (e.g., a mouse or a trackball) through which a user can provide input to the computer. Other types of devices may also be used to provide an interaction with a user. For example, the feedback provided to a user may be any form of sensory feedback (e.g., visual feedback, auditory feedback, or tactile feedback); and the inputs from a user may be received in any form, including acoustic input, voice input, or tactile input.

The systems and techniques described herein may be implemented in a computing system (for example, as a data server) that includes back-end components, or be implemented in a computing system (for example, an application server) that includes middleware components, or be implemented in a computing system (for example, a user computer with a graphical user interface or a web browser through which the user may interact with the implementation of the systems and technologies described herein) that includes front-end components, or be implemented in a computing system that includes any combination of such back-end components, intermediate components, or front-end components. The components of the system may be interconnected by any form or medium of digital data communication (for example, a communication network). Examples of communication networks include: a Local Area Network (LAN), a Wide Area Network (WAN), the Internet.

The computer system may include a client and a server. The client and the server are generally remote from each other and typically interact through a communication network. The client-server relationship is generated by computer programs that run on respective computers and have a client-server relationship with each other.

It should be understood that various forms of processes shown above may be used to reorder, add, or delete steps. For example, respective steps described in the present disclosure may be executed in parallel, or may be executed sequentially, or may be executed in a different order, as long as the desired result of the technical solution disclosed in the present disclosure can be achieved, to which no limitation is made herein.

The above specific embodiments do not constitute a limitation on the protection scope of the present disclosure. It should be understood by those skilled in the art that various modifications, combinations, sub-combinations, and substitutions may be made according to design requirements and other factors. Any modification, equivalent replacement and improvement, and the like made within the spirit and principle of the present disclosure shall be fall in the protection scope of the present disclosure.

What is claimed is:

1. A content recommendation method, comprising:
determining, among candidate producers, a target producer to whom a private domain content recommendation is performed according to product information of the candidate producers;
establishing a recommended product set according to correlation among product information of the target producer; and
performing a private domain content recommendation to the target producer based on the recommended product set.

2. The method according to claim 1, wherein determining, among the candidate producers, the target producer to whom the private domain content recommendation is performed according to the product information of the candidate producers, comprises:
performing quality evaluation on the candidate producers by using Pagerank algorithm according to the product information of the candidate producers; and
determining, among the candidate producers, the target producer to whom the private domain content recommendation is performed according to a result of the quality evaluation.

3. The method according to claim 1, further comprising:
constructing a knowledge graph according to the product information of the target producer; and
establishing the correlation among the product information of the target producer according to the knowledge graph.

4. The method according to claim 2, further comprising:
constructing a knowledge graph according to the product information of the target producer; and
establishing the correlation among the product information of the target producer according to the knowledge graph.

5. The method according to claim 1, further comprising:
constructing a knowledge graph according to the product information of the target producer, wherein the knowledge graph comprises correlation coefficients among the product information of the target producer;
optimizing the correlation coefficients by using user behavior data; and
establishing the correlation among the product information of the target producer by using the optimized correlation coefficients.

6. The method according to claim 2, further comprising:
constructing a knowledge graph according to the product information of the target producer, wherein the knowledge graph comprises correlation coefficients among the product information of the target producer:
optimizing the correlation coefficients by using user behavior data; and
establishing the correlation among the product information of the target producer by using the optimized correlation coefficients.

7. The method according to claim 1, further comprising:
performing effect evaluation on the private domain content recommendation by using a private domain recommendation effect measurement model; and
optimizing the recommended product set according to a result of the effect evaluation.

8. The method according to claim 2, further comprising:
performing effect evaluation on the private domain content recommendation by using a private domain recommendation effect measurement model; and
optimizing the recommended product set according to a result of the effect evaluation.

9. The method according to claim 7, further comprising performing the effect evaluation on the private domain content recommendation by means of at least one of following factors in the private domain recommendation effect measurement model:
a result of the quality evaluation of the target producer, content correlation among the product information of the target producer, quality of products in the recommended product set, and price correlation among the product information of the target producer.

10. An electronic device, comprising:
at least one processor; and
a memory communicatively connected to the at least one processor, wherein
the memory stores instructions executable by the at least one processor, and the instructions are executed by the at least one processor to enable the at least one processor to:
determine, among candidate producers, a target producer to whom a private domain content recommendation is performed according to product information of the candidate producers;
establish a recommended product set according to correlation among product information of the target producer; and
perform a private domain content recommendation to the target producer based on the recommended product set.

11. The electronic device according to claim 10, wherein the instructions are executed by the at least one processor to further enable the at least one processor to:
perform quality evaluation on the candidate producers by using Pagerank algorithm according to the product information of the candidate producers; and
determine, among the candidate producers, the target producer to whom the private domain content recommendation is performed according to a result of the quality evaluation.

12. The electronic device according to claim 10, wherein the instructions are executed by the at least one processor to further enable the at least one processor to:
construct a knowledge graph according to the product information of the target producer; and
establish the correlation among the product information of the target producer according to the knowledge graph.

13. The electronic device according to claim 11, wherein the instructions are executed by the at least one processor to further enable the at least one processor to:
construct a knowledge graph according to the product information of the target producer; and
establish the correlation among the product information of the target producer according to the knowledge graph.

14. The electronic device according to claim 10, wherein the instructions are executed by the at least one processor to further enable the at least one processor to:
construct a knowledge graph according to the product information of the target producer, wherein the knowledge graph comprises correlation coefficients among the product information of the target producer;
optimize the correlation coefficients by using user behavior data; and
establish the correlation among the product information of the target producer by using the optimized correlation coefficients.

15. The electronic device according to claim 11, wherein the instructions are executed by the at least one processor to further enable the at least one processor to:
construct a knowledge graph according to the product information of the target producer, wherein the knowledge graph comprises correlation coefficients among the product information of the target producer;
optimize the correlation coefficients by using user behavior data; and
establish the correlation among the product information of the target producer by using the optimized correlation coefficients.

16. The electronic device according to claim 10, wherein the instructions are executed by the at least one processor to further enable the at least one processor to:
perform effect evaluation on the private domain content recommendation by using a private domain recommendation effect measurement model; and
optimize the recommended product set according to a result of the effect evaluation.

17. The electronic device according to claim 11, wherein the instructions are executed by the at least one processor to further enable the at least one processor to:
perform effect evaluation on the private domain content recommendation by using a private domain recommendation effect measurement model; and
optimize the recommended product set according to a result of the effect evaluation.

18. The electronic device according to claim 16, wherein the instructions are executed by the at least one processor to further enable the at least one processor to perform the effect evaluation on the private domain content recommendation by means of at least one of following factors in the private domain recommendation effect measurement model:
a result of the quality evaluation of the target producer, content correlation among the product information of the target producer, quality of products in the recommended product set, and price correlation among the product information of the target producer.

19. A non-transitory computer-readable storage medium storing computer instructions, wherein the computer instructions, when executed by a computer, cause the computer to:
determine, among candidate producers, a target producer to whom a private domain content recommendation is performed according to product information of the candidate producers;
establish a recommended product set according to correlation among product information of the target producer; and
perform a private domain content recommendation to the target producer based on the recommended product set.

20. The non-transitory computer-readable storage medium according to claim 19, wherein the computer instructions, when executed by a computer, further cause the computer to;
perform quality evaluation on the candidate producers by using Pagerank algorithm according to the product information of the candidate producers; and
determine, among the candidate producers, the target producer to whom the private domain content recommendation is performed according to a result of the quality evaluation.
